(19) United States
(12) Patent Application Publication
(10) Pub. No.: US 2022/0235661 A1
(43) Pub. Date: Jul. 28, 2022

(54) NITROGEN DRIVEN DC GENERATOR

(71) Applicant: Air Liquide Large Industries U.S. LP, Houston, TX (US)

(72) Inventor: Robert D. HOFF, JR., Cleveland, TX (US)

(21) Appl. No.: 17/583,950

(22) Filed: Jan. 25, 2022

Related U.S. Application Data
(60) Provisional application No. 63/141,147, filed on Jan. 25, 2021.

(51) Int. Cl. F01C 1/02; F01C 13/00; F01C 21/00

(52) U.S. Cl. CPC F01C 1/0207; F01C 21/007; F01C 13/00

(57) ABSTRACT

A man-portable backup power generation method including introducing a compressed nitrogen gas stream into an expander turbine, expanding the compressed nitrogen gas stream within the expander turbine, thereby producing a rotational mechanical output, and introducing the rotational mechanical output into a power generator coupled to the expander turbine, thereby producing an electrical output.

### CROSS REFERENCE TO RELATED APPLICATIONS

This application claims the benefit of priority under 35 U.S.C. § 119 (a) and (b) to U.S. Provisional Patent Application No. 63/141,147, filed Jan. 25, 2021, the entire contents of which are incorporated herein by reference.

### BACKGROUND

Industrial facilities and equipment are often found in remote regions, far from cities and towns and, often, far removed from reliable sources of power, e.g., electrical power supplied by an electrical power grid. Power is essential, however, to operate this equipment (e.g., metering stations, local control systems, etc.). At some sites, for example, industrial pipelines transporting oxygen or nitrogen may be monitored for irregularities, which sometimes may lead to leaks that discharge gases at significant environmental and financial costs

These remote systems often make use of alternative power sources to operate pumps and other components in lieu of the electrical power supply via connection with the electrical power grid. Although combustion-based devices (e.g., gas generators) may be used, preference is given to alternative energy sources (e.g., solar panels and wind turbines) to avoid fuel costs and hydrocarbon emissions. Some locations may also include storage devices to store energy from the alternative energy sources. The storage devices can supplement output from the alternative sources, e.g., during low-sun and/or low-wind conditions.

Batteries are one common type of storage device. These systems may utilize a number of batteries that form a system or an array. Examples of the array connect the batteries in parallel to meet the discharge and storage needs at each remote sight. However, batteries are known to discharge at slightly different rates. This characteristic can lead to voltage imbalances that impact the amount of current that is drawn from each battery found in the array. As a result, stronger batteries with charge levels that are relatively larger than the charge levels of weaker batteries in the array may tend to carry the weaker batteries when driving a load (e.g., the pump). Operation of the array in this manner can reduce the life-span of the batteries, which in turn will require maintenance at greater frequency to replace dead and/or under-performing batteries at the remote sight.

There is therefore a need within the industry for a reliable backup system for critical remote electrically powered systems.

### SUMMARY

A man-portable backup power generation method including introducing a compressed nitrogen gas stream into an expander turbine, expanding the compressed nitrogen gas stream within the expander turbine, thereby producing a rotational mechanical output, and introducing the rotational mechanical output into a power generator coupled to the expander turbine, thereby producing an electrical output.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of one embodiment of the present invention.

FIG. 2 is another schematic representation of one embodiment of the present invention.

FIG. 3 is another schematic representation of one embodiment of the present invention.

FIG. 4 is another schematic representation of one embodiment of the present invention.

### ELEMENT NUMBERS

101=nitrogen gas stream
102=expander turbine
103=power generator
104=mechanical coupling (between expander turbine and power generator
105=electrical output
106=nitrogen pipeline
107=compressed nitrogen storage tank
108=control cabinet
109=low pressure nitrogen exhaust stream
110=main circuit breaker—AC/DC power supply (in control cabinet)
111=electrical power grid
112=electrical current sensor
113=electrical power switch (to control cabinet)
114=programmable logic controller
115=nitrogen gas control valve

### DETAILED DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

One embodiment of the present invention utilizes a compressed gas (with for example, nitrogen being the most commonly available) from a pipeline or any other compressed gas source (such as a compressed nitrogen storage tank) to spin a miniature expander turbine which will in turn rotate a small power generator. This power may then be used locally, for example by a pipeline meter station. This turbine/generator may be small and potentially man-portable, possibly being no larger than a small suitcase. These turbine/generators may be placed within a commercially available protective case, such as a Pelican, or Seahorse case. Thus, they may be easily distributed as needed, for example throughout the network, for use during prolonged power outages. Permanent units may also be built into the control cabinets for locations where electrical power grid AC power is unavailable or unreliable. The turbine/generator may be available in several different sizes as required to accommodate different electrical loads.

The turbine/generator may comprise a nitrogen driven scroll-type expander that is coupled to a DC generator to provide emergency power to local pipeline stations. Scroll-type expanders are known in the art, as indicated for example in U.S. Pat. No. 4,314,796. This generator may be designed to run continuously however their normal duty would likely be to operate them in a standby mode and only utilize their capacity during a loss of AC or solar power. The backup power generation method may, during normal/standby operation have a compressed nitrogen stream flow rate of zero, wherein compressed nitrogen is not allowed to enter the expander turbine and the electrical output is zero. And may, during a loss of local power, allow the compressed nitrogen stream to enter the expander and the electrical output satisfies local demand.

The generator may be very small, possibly about the size of a large lunch box (for example 10″×10″×6″) and may be installed inside existing cabinets. The backup power generation method may include an expander turbine and power generator which, along with the associated control and ancillary equipment, have overall dimensions of less than 20 inches in width, 20 inches in depth, and 20 inches in height, preferably less than 15 inches in width, 15 inches in depth, and 15 inches in height, more preferably less than 10 inches in width, 10 inches in depth, and 10 inches in height.

The backup power generation method may include an expander turbine and a power generator which, along with the associated control and ancillary equipment, have a combined weight of less than 75 lb, preferably less than 50 lb, more preferably less than 35 lb.

The exhaust from the unit may provide the cabinet with a nitrogen purge. As these cabinets typically are already purged and this unit may be designed to utilize the existing tubing that's already in place. The generator unit may provide 30 VDC or less. The generator unit may be been designed to provide 24 VDC, a common voltage used in instrumentation devices.

In some embodiments, during operation, the unit may produce less than approximately 500 watts, preferably less than approximately 250 watts, more preferably less than approximately 125 watts or about 5 amps power. This DC power may be feed directly to the cabinet batteries providing charge and operating voltage. The existing flow computer may be used to open a solenoid valve when the voltage falls to a predetermined level, the open valve may provide nitrogen gas to the scroll expander and thus begin generating power.

As used herein, the term “approximately 500 watts” is defined as being between 480 and 520 watts as measured at the generator output. As used herein, the term “approximately 250 watts” is defined as being between 235 and 265 watts as measured at the generator output. As used herein, the term “approximately 125 watts” is defined as being between 115 and 135 watts as measured at the generator output. As used herein, the term “approximately 5 amps DC” is defined as being between 4 amps and 6 amps DC as measured at the generator output”.

When the batteries reach a sufficient level of charge the flow computer may (close the solenoid valve which in turn will shut down the scroll expander. The device, may be used to operate remote stations, it may be used on pig skids etc. Also, since the device is very small and designed to reside inside a locked cabinet, this device may be used in remoter areas, possibly in other countries, where solar panels are often stolen and AC power is intermittent or unavailable.

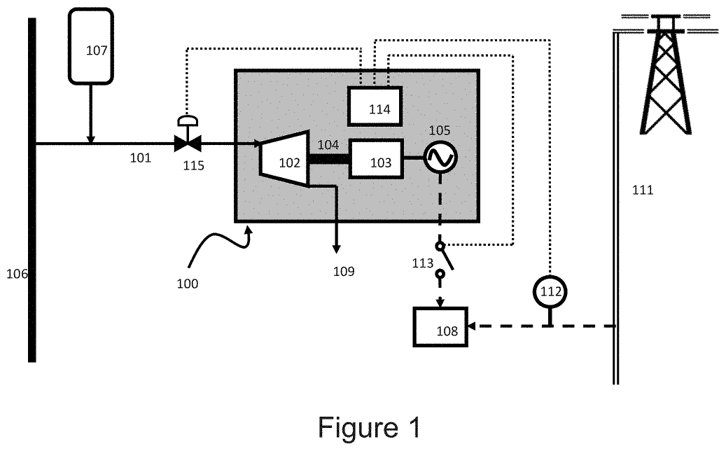

Turning to FIGS. 1 to 4, one embodiment of the present invention is presented. Nitrogen gas stream 101 may come from nitrogen pipeline 106, compressed nitrogen storage tank 107, or any other available source of compressed nitrogen (not shown). The flowrate of nitrogen gas stream 101 into man-portable backup power generator 100 is regulated by nitrogen gas control valve 115. Nitrogen gas stream 101 then enters the inlet port of expander turbine 102. Within expander turbine 102 the compressed nitrogen expands and produces a rotational mechanical output which is transferred, through mechanical coupling 104, into power generator 103. Power generator 103 thus produces electrical output 105.

As indicated in FIG. 1, during normal, or standby, operation, electrical power is available from electrical power grid 111. This electrical power is sensed by electrical current sensor 112, which sends a signal to programmable logic controller 114. If programmable logic controller 114 senses the availability of electrical power from electrical power grid 111, it sends a signal to close nitrogen gas control valve 115. Thus, no nitrogen enters expander turbine 102, and no electrical output 105 is produced by power generator 103.

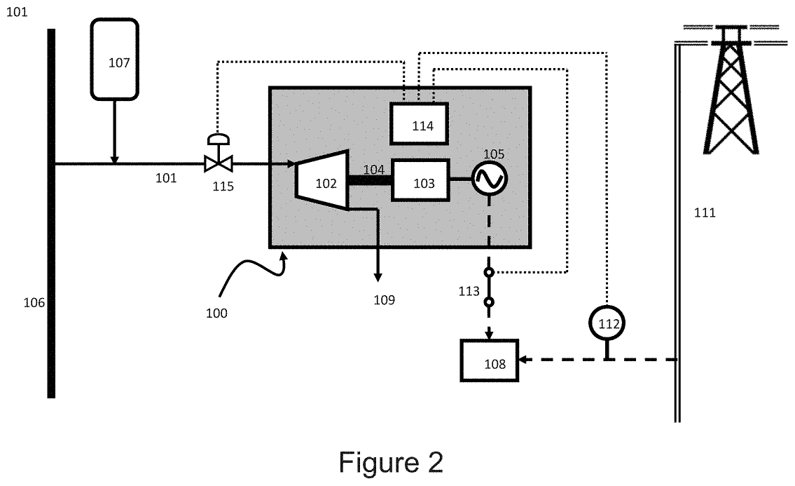

As indicated in FIG. 2, during a loss of power from electrical power grid 111, electrical current sensor 112 sends a different signal to programmable logic controller 114. In this case, programmable logic controller 114 fails to sense electrical power from the electrical power grid 111, and now it sends a signal to open nitrogen gas control valve 115. Now, nitrogen enters expander turbine 102, and electrical output 105 is produced by power generator 103. Low pressure nitrogen exhaust stream 109 exits expander turbine 102 and is exhausted into the atmosphere. The flowrate of electrical output 105 is then controlled by electrical power switch 113. Electrical power switch 113 closes, and thus allows electrical power to enter control cabinet 108.

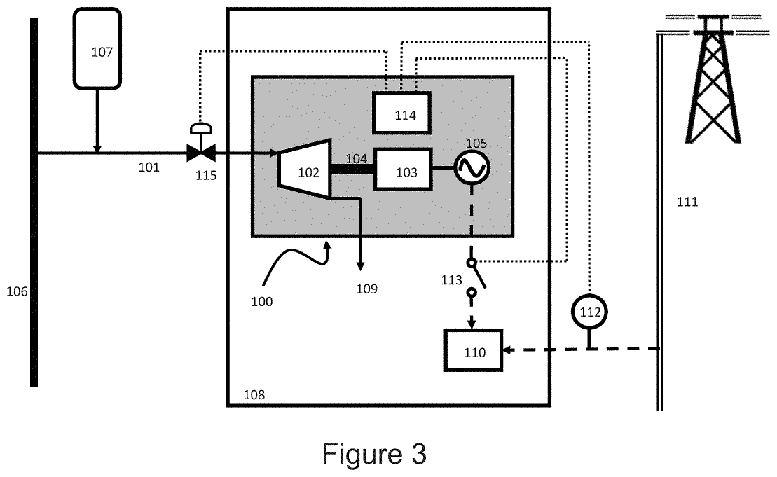

FIG. 3 illustrates a normal, or standby, operation as described above in FIG. 1, with the exception that man-portable backup power generator 100 is permanently installed in control cabinet 108. In this operational scenario, no nitrogen gas 101 enters expander turbine 102, no electrical output 105 is produced, and electrical power switch 113 is open.

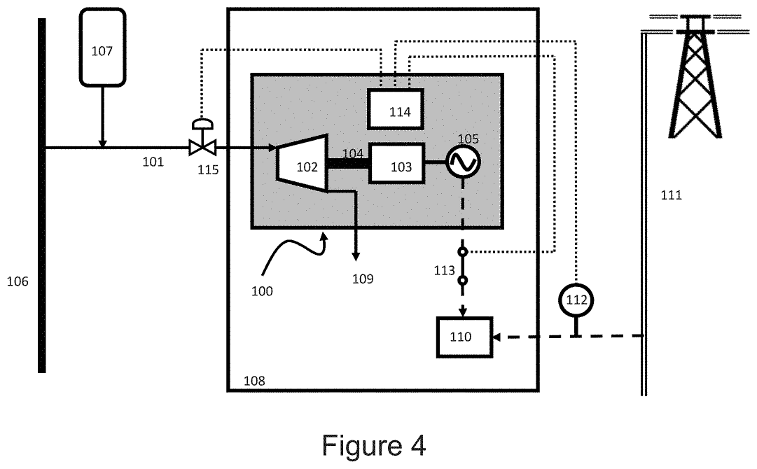

FIG. 4 illustrates an operation during a loss of power as described above in FIG. 2, with the exception that man-portable backup power generator 100 is permanently installed in control cabinet 108. In this operational scenario, nitrogen gas 101 enters expander turbine 102, electrical output 105 is produced, and electrical power switch 113 is closed. This allows power to be provided to control cabinet 108, specifically to main circuit breaker or AC/DC power supply 110. In this scenario, low pressure nitrogen exhaust stream is used to purge control cabinet 108.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed:

1. A man-portable backup power generation method comprising:
introducing a compressed nitrogen gas stream into an expander turbine,
expanding the compressed nitrogen gas stream within the expander turbine, thereby producing a rotational mechanical output,
introducing the rotational mechanical output into a power generator coupled to the expander turbine, thereby producing an electrical output.

2. The man-portable backup power generation method of claim 1, wherein the expander turbine and power generator have a combined weight of less than 75 lb.

3. The man-portable backup power generation method of claim 1, wherein the expander turbine and power generator have a combined weight of less than 50 lb. The man-portable backup power generation method of claim 1, wherein the expander turbine and power generator have a combined weight of less than 35 lb.

5. The man-portable backup power generation method of claim 1, wherein the expander turbine and power generator have overall dimensions of less than 20 inches in width, 20 inches in depth, and 20 inches in height.

6. The man-portable backup power generation method of claim 1, wherein the expander turbine and power generator have overall dimensions of less than 15 inches in width, 15 inches in depth, and 15 inches in height.

7. The man-portable backup power generation method of claim 1, expander turbine and power generator have overall dimensions of less than 10 inches in width, 10 inches in depth, and 10 inches in height.

8. The man-portable backup power generation method of claim 1, wherein the compressed nitrogen gas stream is provided by compressed nitrogen storage tank.

9. The man-portable backup power generation method of claim 1, wherein the compressed nitrogen gas stream is provided by a nitrogen pipeline.

10. The man-portable backup power generation method of claim 1, wherein the electrical output is less than 30 volts DC.

11. The man-portable backup power generation method of claim 1, wherein the electrical output is a 24 volts DC.

12. The man-portable backup power generation method of claim 1, wherein the electrical output is less than approximately 250 watts DC.

13. The man-portable backup power generation method of claim 1, wherein the electrical output is approximately 125 watts or approximately 5 amps DC.

14. The man-portable backup power generation method of claim 1, wherein the expander turbine is a scroll-type expander.

15. The man-portable backup power generation method of claim 1, wherein
during normal/standby operation the compressed nitrogen stream is not allowed to enter the expander turbine and the electrical output is zero, and
during a loss of local power, the compressed nitrogen stream is allowed to enter the expander turbine and the electrical output satisfies local demand.

16. The man-portable backup power generation method of claim 1, wherein the electrical output is used to provide power to a control cabinet.

17. The man-portable backup power generation method of claim 1, wherein the expander turbine and power generator are permanently installed in the control cabinet.

18. The man-portable backup power generation method of claim 1, wherein the expander turbine produces a low-pressure nitrogen exhaust stream which is used to purge the control cabinet.
